(19) United States
(12) Patent Application Publication
(10) Pub. No.: US 2025/0387214 A1
(43) Pub. Date: Dec. 25, 2025

(54) EQUINE DENTAL SPECULUM

(71) Applicant: Louis D. Jeffrey, King Hill, ID (US)

(72) Inventor: Louis D. Jeffrey, King Hill, ID (US)

(21) Appl. No.: 18/748,906

(22) Filed: Jun. 20, 2024

(51) Int. Cl. A61D 15/00; A61D 5/00

(52) U.S. Cl. CPC A61D 15/00; A61D 5/00

(57) ABSTRACT

A speculum having an upper frame with a front side, a rear side, a left side and a right side and the front side is connected to an upper tooth plate. The speculum also includes a lower frame having a front side, a rear side, a left side and a right side and wherein the front side is connected to a lower tooth plate. The speculum includes at least one extendible joint connected to one of the upper frame right side or upper frame left side and the corresponding lower frame left side or lower frame right side.

### FIELD OF THE DISCLOSURE

This disclosure relates generally to speculums. In particular, this disclosure relates to speculums for equine dentistry.

### BACKGROUND

An equine dentistry speculum is a veterinary instrument used in equine dental care. It is designed to hold a horse's mouth open (or other animals in the genus, such as donkeys, mules, zebras, asses, and the like, as well as bovines, cattle, and other herbivores) during dental examinations and procedures, allowing the veterinarian or equine dentist better visibility and access to the teeth. This is particularly important for thorough examinations, routine prophylaxis, equilibration and cleanings, or more complex dental work.

Some existing speculums may cause discomfort or injury to the horse due to poor design or inappropriate fitting. Horses might experience cuts or bruises on their gums and lips or undue pressure on their teeth from ill-fitting tooth plates or jaw joint pain, leading to potential trauma or other long-term issues.

In addition, some existing speculums may not be as durable as required for regular use, leading to a frequent need for replacement or repair. Maintenance can also be challenging if the speculum is not designed for easy cleaning and disinfection, which is crucial to prevent cross-contamination between patients. Likewise, existing speculums can be difficult to assemble or disassemble and can unexpectedly disassemble during use making them difficult to apply on most animals.

Furthermore, some existing speculums are cumbersome or difficult to adjust and can hinder the efficiency and speed of dental procedures, which might increase stress for both the practitioner and the horse. The need for tools that require excessive force to make adjustments can be problematic in an in-the-field setting for treatment.

Likewise, some speculums may not accommodate the full range of incisor dental anomalies, mouth sizes, and shapes found in different breeds or ages of horses, which can limit their usefulness. In addition, inadequate balance and lack of even pressure on incisor teeth during mouth opening can make the horse ill-tempered, restricting ability to work, and practitioner access to the back teeth, which are often where the most serious dental issues occur.

Similarly, poor speculum design for some existing models obstructs the practitioner's view, particularly of the posterior dental arcades, making it difficult to perform a comprehensive examination or precise procedures.

Currently, most speculums are hinge style units, meaning they open from a hinge or pivot at the back. With this type of unit, the angle of the tooth plates against the incisor occlusal surface is always changing as the speculum opens. This creates excessive pressure on the incisor teeth due to the fact that only the leading edges of the incisor teeth fit against the surfaces of the tooth plates. This excessive tooth plate to incisor edges tooth pressure causes the horse to become ill-tempered during dental procedures being performed on the back (cheek) teeth. Likewise, the tooth plates of this single-hinge style unit rarely fit the incisor table angle of the horse's mouth. Among other things, this can cause the speculum to slip off the teeth more easily when in use because of the excessive angle and relationship of the tooth plates to the occlusal plane of the incisors.

Current hinge style speculums are also more difficult to open because of their hinge design, the horse's resistance to the same, and the need for more force to open the mouth with this type of unit. In addition, the solid frame design used in this type of unit is more restricting and not very forgiving for/to the horse. Other drawbacks, inefficiencies, issues, and inconveniences also exist for current speculums.

### SUMMARY

Accordingly, disclosed embodiments address the above and other drawbacks, inefficiencies, issues, and inconveniences with existing speculums. For example, many times the discomfort with existing speculums puts the animal “on the fight” making it difficult to accomplish needed dental procedures such as floating teeth and routine and advanced maintenance work. These problems arise from the over confinement required to prevent any movement of the horse and the excessive pressure to edges of the incisor teeth. This excessive pressure is very painful to the individual patient. Some existent speculums lack working room for the dental tools. Disclosed embodiments provide the practitioner with maximum working area for instruments.

Embodiments of the herein disclosed speculum do not have a rear hinge joint eliminating the ever-changing tooth plate angle. As embodiments of the disclosed speculum open, the tooth plates maintain correct incisor table angle because the upper and lower frames separate parallel maintaining a more correct incisor tooth plate angle for each horse. Furthermore, the disclosed swivel ball tooth plates rotate in all positions allowing final optimal adjustment for each horse's incisor table angle, which have many angle variations and anomalies, creating comfort and correct temperament during most dental procedures.

Disclosed embodiments open with the upper frame raising and moving out of the way, leaving the lower frame high, and the jaw line free for support through use of hanging halters, cradles, crutches, and the like. Additionally, the parallel frames are much easier to open than hinge style frames. Disclosed embodiments also allow for greater working room for instruments.

Disclosed embodiments include, but are not limited to, the following features. Embodiments of the speculum include extra-wide, large surface, swivel ball tooth plates that stay in the speculum, do not fall out, and are adjustable. Embodiments are user and horse friendly with articulating adjustable swivel ball tooth plates that adapt to most incisor table angles, including wedged shaped incisors.

Embodiments also include parallel, easy-to-open and close frames, there is no need to pry the animal's mouth open. Embodiments also work with animals with temporomandibular joint (TMJ) issues by minimizing pressure to joints, muscles and tissues. Embodiments provide more comfort for the horse, requiring minimal restraint of the same. Embodiments also do not interfere with hanging halters or head stands. Empirically, horses and other animals appear to like embodiments of the disclosed speculum better than most other types and embodiments allow more freedom for the animals.

Disclosed embodiments include a speculum having an upper frame, a lower frame, an extendible joint connecting the upper frame and the lower frame, an upper tooth plate connected to the upper frame with a first swivel ball joint, and a lower tooth plate connected to the lower frame with a second swivel ball joint.

Further disclosed embodiments include a ratchet configured to operate the extendible joint to extend into an open position.

In some embodiments the extendible joint is a scissor joint.

In some embodiments a tapered locking nut to secure the first and/or second swivel ball joints in a desired position.

In some embodiments the upper frame further includes a first upper side arm; and a second upper side arm, and wherein, in use, the first upper side arm is configured to be positioned on a first side of an animal's head and the second upper side arm is configured to be positioned on a second side of an animal's head.

In further disclosed embodiments the upper tooth plate is connected between the first upper side arm and the second upper side arm. In further disclosed embodiments the upper tooth plate is connected to the first upper side arm with the first swivel ball joint and is connected to the second upper side arm with another swivel ball joint.

In further disclosed embodiments the lower frame includes a first lower side arm, and a second lower side arm, and wherein, in use, the first lower side arm is configured to be positioned on a first side of an animal's head and the second lower side arm is configured to be positioned on a second side of an animal's head.

In further disclosed embodiments the lower tooth plate is connected between the first lower side arm and the second lower side arm. In further disclosed embodiments the lower tooth plate is connected to the first lower side arm with the second swivel ball joint and is connected to the second lower side arm with another swivel ball joint.

In some embodiments the first upper side arm and the first lower side arm are connected through a first extendible joint and the second upper side arm and the second lower side arm are connected through a second extendible joint. In some embodiments the first extendible joint comprises a scissor joint.

Disclosed embodiments include a ratchet operable to extend the first extendible joint into an open position.

Disclosed embodiments also include a speculum having an upper frame with a front side, a rear side, a left side and a right side and wherein the front side is connected to an upper tooth plate. Embodiments also include a lower frame with a front side, a rear side, a left side and a right side and wherein the front side is connected to a lower tooth plate, and at least one extendible joint connected to one of the upper frame right side or upper frame left side and the corresponding lower frame left side or lower frame right side.

In some embodiments a ratchet configured to operate the at least one extendible joint to extend into an open position. In some embodiments the ratchet may be replaced by a sliding clamp, or the like.

In some embodiments the extendible joint comprises a scissor joint.

In some embodiments the upper tooth plate is connected to the upper frame with at least one swivel ball joint. In some embodiments the lower tooth plate is connected to the lower frame with at least one swivel ball joint.

In some embodiments a tapered locking nut to secure the at least one swivel ball joint in a desired position.

Other embodiments also exist.

### BRIEF DESCRIPTION OF THE DRAWINGS

FIG. 1 is an isometric view of a speculum in a closed position in accordance with disclosed embodiments.

FIG. 2 is an isometric view of the speculum of FIG. 1 in an open position in accordance with disclosed embodiments.

FIG. 3 is a top view of a speculum tooth plate in accordance with disclosed embodiments.

FIGS. 4A-4B are top and cut-away side views, respectively, of a lock nut for the tooth plates in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

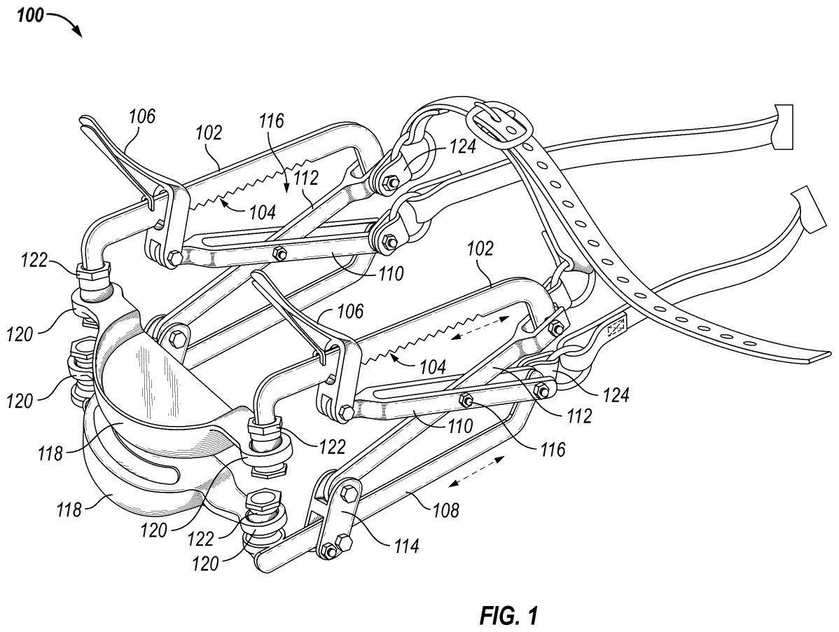

FIG. 1 is an isometric view of a speculum 100 in a closed position in accordance with disclosed embodiments. As illustrated, embodiments of speculum 100 may include an upper frame 102. Ratchet teeth 104 may be on underside of upper frame 102 and operatively engage with a complementary pawl part of ratchet lever 106 as described herein. As those of ordinary skill in the art having the benefit of this disclosure would understand, the configuration of the pawl in ratchet lever 106 and ratchet teeth 104 may be reversed, may be located on the top of upper frame 102, and the like. As also shown embodiments of speculum 100 may include a lower frame 108.

In some embodiments, upper frame 102 and lower frame 108 are connected through an expandable/contractable scissor joint 116 that may include a scissor clevis 110 and a scissor tongue 112. As illustrated one end of scissor clevis 110 is connected to ratchet lever 106 and the other end is connected to the lower frame 108. Likewise, one end of scissor tongue 112 is connected to lower slide block 114 and the other end is connected to upper frame 102. As noted above and as those of ordinary skill in the art having the benefit of this disclosure would understand, the configuration of these parts may also be operatively reversed.

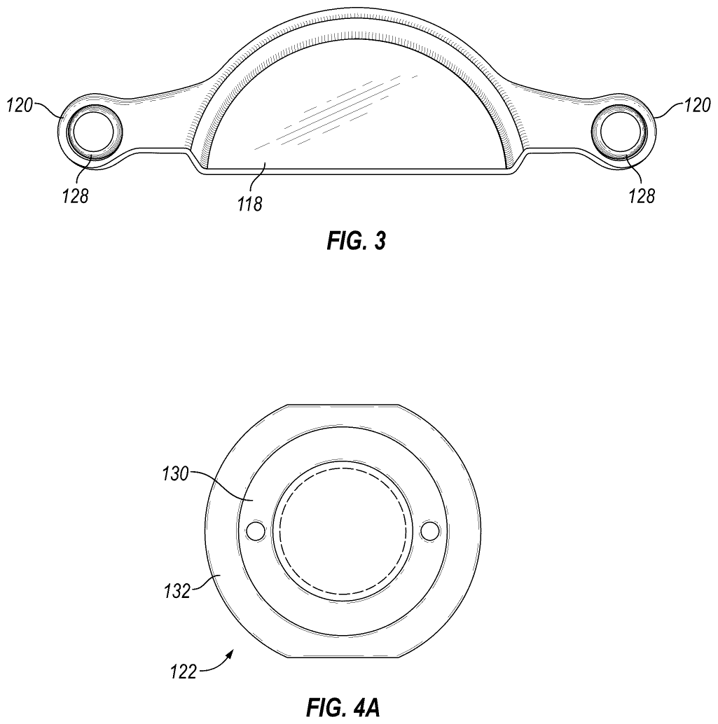

Embodiments of speculum 100 may also include tooth plates 118 (one upper, one lower) each having a swivel ball joint 120 (better seen in FIG. 3) at each end and secured by a respective lock nut 122. Embodiments of speculum 100 also include D-rings 124 or other attachment points to which a head harness 126 may be connected in order to secure the speculum 100 to the head of the animal patient.

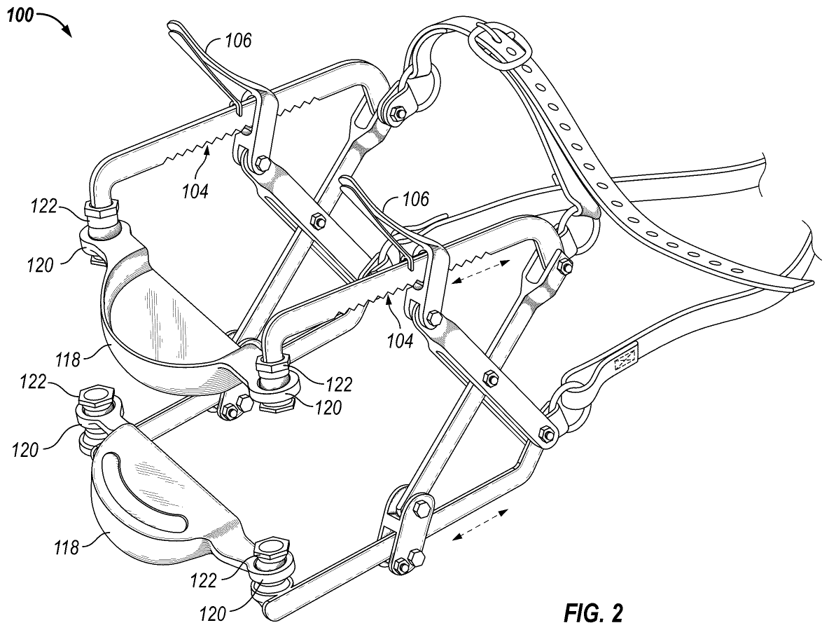

FIG. 2 is an isometric view of speculum 100 of FIG. 1 in an open position in accordance with disclosed embodiments and wherein like numbers denote like parts. As those of ordinary skill in the art having the benefit of this disclosure would understand, operation of ratchet lever 106 moves along upper frame 102 in the direction indicated by motion arrow between closed and open positions. In turn, scissor joint 116 moves lower slide block 114 along lower frame 108 in the direction of motion arrow. This motion causes upper frame 102 and lower frame 108 to separate as indicated and correspondingly separates upper and lower tooth plates 118. In use, a horse's teeth (or other similar animal patient) are put into the respective tooth plates 118 and operation of the speculum as described herein causes the upper and lower jaws to separate and be held in place to an amount dictated by the operation of the ratchet lever 106. As will be understood by those of ordinary skill in the art having the benefit of this disclosure, release of the ratchet pawl allows movement back to the closed position shown in FIG. 1.

FIG. 3 is a top view of a speculum 100 tooth plate 118 in accordance with disclosed embodiments. The features of tooth plate 118 described herein are applicable to both the upper and lower tooth plates 118. As illustrated each tooth plate 118 includes a swivel ball joint 120 that includes a ball 128 that allows for pivotal and rotary motion of the joint 120. As disclosed herein, the tooth plates 118 maintain correct incisor table angle because the upper 102 and lower 108 frames separate in a parallel maintaining a more correct incisor tooth plate 118 angle for each horse or animal. Furthermore, the disclosed swivel ball joint 120 allows the tooth plates 118 to rotate in all positions allowing final optimal adjustment for each horse's incisor table angle, which have many angle variations and anomalies, creating comfort and correct temperament during most dental procedures. Each swivel ball joint 120 may be secured using lock nut 122 as described below.

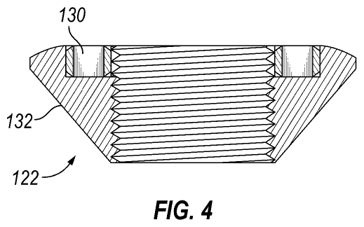

FIGS. 4A-4B are top and cut-away side views, respectively, of a lock nut 122 for the tooth plates 118 in accordance with disclosed embodiments. As indicated, embodiments of lock nut 122 include a lock ring 130 to hold the lock nut at a desired place on a correspondingly threaded post (in each of the ends of the upper frame 102 and lower frame 108 as shown in FIGS. 1-2). Embodiments of lock nut 122 also include a tapered spacer 132 to assist in holding swivel ball joint 128 in a desired orientation.

Although various embodiments have been shown and described, the present disclosure is not so limited and will be understood to include all such modifications and variations would be apparent to one skilled in the art.

What is claimed is:

1. A speculum comprising:
an upper frame;
a lower frame;
an extendible joint connecting the upper frame and the lower frame;
an upper tooth plate connected to the upper frame with a first swivel ball joint; and
a lower tooth plate connected to the lower frame with a second swivel ball joint.

2. The speculum of claim 1 further comprising a ratchet configured to operate the extendible joint to extend into an open position.

3. The speculum of claim 1 wherein the extendible joint comprises a scissor joint.

4. The speculum of claim 1 further comprising a tapered locking nut to secure the first swivel ball joint in a desired position.

5. The speculum of claim 1 further comprising a tapered locking nut to secure the second swivel ball joint in a desired position.

6. The speculum of claim 1 wherein the upper frame further comprises:
a first upper side arm; and
a second upper side arm; and
wherein, in use, the first upper side arm is configured to be positioned on a first side of an animal's head and the second upper side arm is configured to be positioned on a second side of an animal's head.

7. The speculum of claim 6 wherein the upper tooth plate is connected between the first upper side arm and the second upper side arm.

8. The speculum of claim 7 wherein the upper tooth plate is connected to the first upper side arm with the first swivel ball joint and is connected to the second upper side arm with another swivel ball joint.

9. The speculum of claim 6 wherein the lower frame further comprises:
a first lower side arm; and
a second lower side arm; and
wherein, in use, the first lower side arm is configured to be positioned on a first side of an animal's head and the second lower side arm is configured to be positioned on a second side of an animal's head.

10. The speculum of claim 9 wherein the lower tooth plate is connected between the first lower side arm and the second lower side arm.

11. The speculum of claim 10 wherein the lower tooth plate is connected to the first lower side arm with the second swivel ball joint and is connected to the second lower side arm with another swivel ball joint.

12. The speculum of claim 9 wherein the first upper side arm and the first lower side arm are connected through a first extendible joint and the second upper side arm and the second lower side arm are connected through a second extendible joint.

13. The speculum of claim 12 wherein the first extendible joint comprises a scissor joint.

14. The speculum of claim 13 further comprising a ratchet operable to extend the first extendible joint into an open position.

15. A speculum comprising:
an upper frame comprising a front side, a rear side, a left side and a right side and wherein the front side is connected to an upper tooth plate;
a lower frame comprising a front side, a rear side, a left side and a right side and wherein the front side is connected to a lower tooth plate; and
at least one extendible joint connected to one of the upper frame right side or upper frame left side and the corresponding lower frame left side or lower frame right side.

16. The speculum of claim 15 further comprising a ratchet configured to operate the at least one extendible joint to extend into an open position.

17. The speculum of claim 15 wherein the extendible joint comprises a scissor joint.

18. The speculum of claim 15 wherein the upper tooth plate is connected to the upper frame with at least one swivel ball joint.

19. The speculum of claim 15 wherein the lower tooth plate is connected to the lower frame with at least one swivel ball joint.

20. The speculum of claim 18 further comprising a tapered locking nut to secure the at least one swivel ball joint in a desired position.
